(19) United States
(12) Patent Application Publication
(10) Pub. No.: US 2011/0234051 A1
(43) Pub. Date: Sep. 29, 2011

(54) Self-charging electronic device

(76) Inventors: Berj A. Terzian, Newbury, MA (US); Jack A. Ekchian, Belmont, MA (US)

(21) Appl. No.: 12/802,410

(22) Filed: Jun. 7, 2010

Related U.S. Application Data
(60) Provisional application No. 61/317,495, filed on Mar. 25, 2010.
(60) Provisional application No. 61/316,901, filed on Mar. 24, 2010.

(51) Int. Cl. H02N 2/18

(52) U.S. Cl. 310/339

(57) ABSTRACT

A self-charging device includes a passageway which has piezoelectric elements at its opposite ends. A mobile member is located within the passageway and configured to travel between and collide with the piezoelectric elements. Collisions generate electrical voltage and current. Conductive leads transmit current from the piezoelectric elements to a circuit or to a storage member such as a capacitor or a battery.

### CROSS-REFERENCED TO RELATED APPLICATIONS

This application claims priority to U.S. Provisional Patent Application No. 61/317,495 filed May 25, 2010 and U.S. Provisional Patent Application No. 61316901 filed May 24, 2010, which are hereby incorporated by reference in their entirety.

### BACKGROUND OF THE INVENTION

1. Field of the Invention

This invention relates to electronic devices which need self-charging capability in order to avoid battery depletion and be operable substantially continuously.

2. Drawbacks of Present Devices

Electronic devices such as iPods, cell phones, CD players, Blackberrys, GPS navigations, etc, continue to grow in general usage throughout the world. In addition, they are becoming more and more complicated, thus requiring higher levels of operating power, especially as programmed applications become constantly expanded.

### SUMMARY OF THE INVENTION

The present invention alleviates the need for substantially continuous charging of battery driven electronic devices by providing a new and effective self-charging electronic generator that can be included in the housing of the device. Moreover, by the use of preferred materials in the construction of the self-charging mechanism, it can be quite sturdy and rarely damaged or destroyed.

### BRIEF DESCRIPTION OF THE DRAWINGS

FIG. 1 is a schematic drawing of an embodiment of the invention.

FIG. 2 is a diagram of an exemplary circuit that can self-charge the embodiment of FIG. 1.

### DETAILED DESCRIPTION OF THE INVENTION

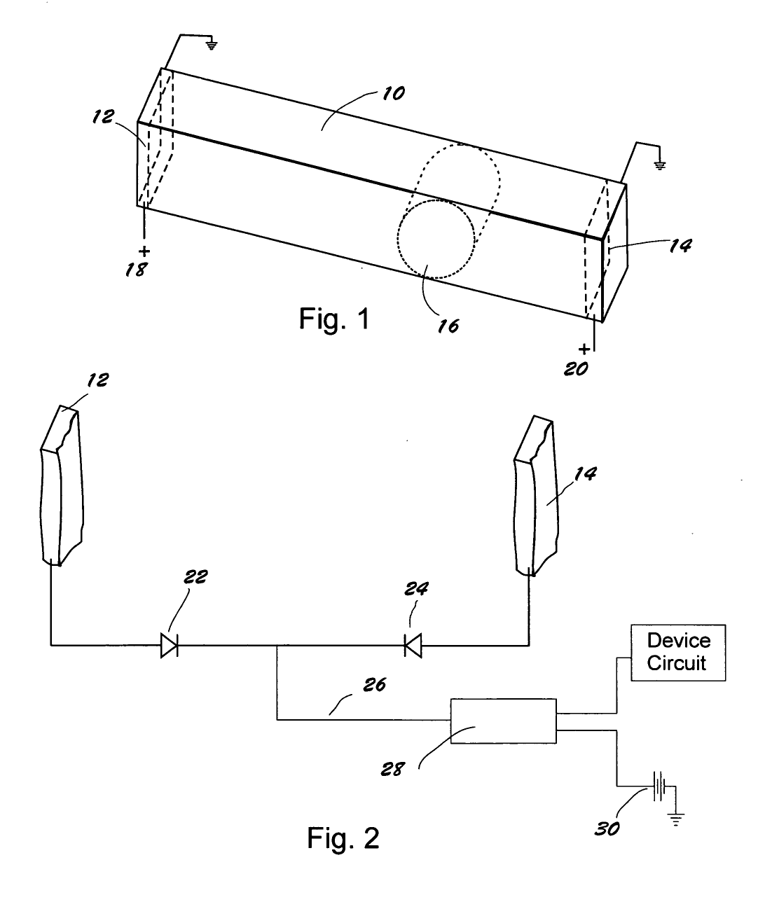

FIG. 1 includes an elongated closed passageway 10 having a rectangular or square cross section. At the ends of the passageway are piezoelectric material pads 12 and 14. Various passageways, such as circular, oval, discs or other multisided cross sections, may also be used.

Within the passageway is a mass 16. Preferably the mass 16 is made of lead or other dense materials having high mass. Preferably, the shape of the mass is a circular cylinder or a sphere although other shapes may be used

When the passageway is oscillated about its central transverse axis a few degrees away from horizontal, mass 16 will correspondingly move sequentially toward the opposite ends of the passageway and thus impact the piezoelectric material 12 and 14. Each impact will generate a pulse of electrical charge which will flow out of the passageway through the positive leads 18 and 20, due to the mechanical distortion of the piezoelectric material caused by the impacts of mass 16.

The greater the distortion of the piezoelectric material pads, the larger will be the magnitude of the resultant pulse. Therefore, heavy mass is the preferred design for optimal pulse generation.

FIG. 2 depicts a simple diagrammatic operating circuit. Positive leads 18 and 20 transmit pulses through diodes 22 and 24 which prevent back current flow from the impacted piezoelectric pad to the opposite non-impacted pad.

The direct current is transmitted by lead 26 to charging circuit 28 from which a battery can be recharged and/or power can be used to operate the device circuit.

The self-charging embodiment of FIG. 1 can be operated by manually oscillating it, as previously described. Alternatively, it can be combined with the mechanical oscillating mechanism disclosed in U.S. Pat. No. 7,479,715 B2, the entirety of which is incorporated by reference herein. Alternatively, the self-charging device may be shaken along the axis of the channel to induce more forceful impact on the piezoelectric pads.

Another option is to manufacture impacting member 16 in the shape of a bar or a cylinder having an axis parallel to the linear axis of passageway 10. This will enable applying vigorous back and forth manual shaking of the passage way for maximum generation of pulses and current flow.

Preferably, piezoelectric material pads 12 and 14 are manufactured from ceramics such as barium and lead titanates, lead zirconate titanate, potassium and lithium niobates. Lead free ceramics can be manufactured from sodium potassium niobate, and bismuth ferrite.

It is also a further object of this invention for the charging system to be separate from the electrical device, such as a cell phone or Ipod. Such a charging device may receive a rechargeable battery that may be removed after it is sufficiently charged.

United States Patent Application Publication No. 2010/0045241 published Feb. 25, 2010, in its entirety is incorporated herein by reference. Paragraphs [0023]-[0025] set forth piezoelectric technology to those of skill in the art.

ILSI America, 5458 Louie Lane, Reno Nev. 89511 is a domestic source of a variety of piezoelectric crystals.

What we claim is:

1. A self-charging electronic device which comprises
(a) an elongated passageway having a selected cross-sectional configuration,
(b) at least one piezoelectric element located at least at one end of the passageway,
(c) a mobile member included within the passageway and capable of moving through the passageway between the ends thereof, whereby impact of the mobile member on said piezoelectric element generates electrical voltage or current.

2. A device according to claim 1 which includes piezoelectric elements at two ends of the passageway.

3. A device according to claim 2 wherein the mobile element is made of at least one dense material in order to increase its mass and the electrical power generated by the impacts thereof on said piezoelectric element.

4. A device according to claim 3 wherein the mobile element includes lead, tungsten or depleted uranium.

5. A device according to claim 1 which includes conductive leads extending from said piezoelectric element to transmit the generated current to a circuit or a storage member, the latter comprising a battery or capacitor.

6. A device according to claim 1 wherein the piezoelectric element is made of a ceramic material comprising barium or lead titanate, lead zirconate titanate, potassium or lithium niobate, or bismuth ferrite.

7. A device according to claim 1 wherein the passageway has a rectangular cross-section and said mobile member is a disc configured to roll on its edge through said passageway to impact said piezoelectric element, thereby generating multiple pulses of voltage or current.

8. A device according to claim 3 wherein the electrical current is passed through at least one diode to rectify said current.

9. A method of self-charging an electronic device which comprises:
(a) providing the device with an elongated passageway having a selected cross-sectional configuration,
(b) including a piezoelectric element at least at one end of the passageway,
(c) locating a mobile member within the passageway which is capable of colliding with said piezoelectric element, thereby generating electrical voltage or current.

10. A method according to claim 9 which comprises including piezoelectric elements at two ends of the passageway.

11. A method according to claim 10 which comprises selecting a dense substance as a material of the mobile member.

12. A method according to claim 11 which comprises selecting lead, tungsten or depleted uranium as said dense substance.

13. A method according to claim 9 which comprises providing a piezoelectric element manufactured from a ceramic material comprising barium or lead titanate, lead zirconate titanate, potassium or lithium niobate, or bismuth ferrite.

14. A method according to claim 9 which comprises shaping the passageway in a rectangular cross-sectional configuration and forming the mobile element as a disc capable of rolling on its edge in said passageway, thereby causing multiple collisions of the disc on said piezoelectric element to generate electrical voltage or current.

15. A method according to claim 14 which comprises conducting the generated electric current through at least one diode to rectify said current.
